(19) United States
(12) Patent Application Publication
(10) Pub. No.: US 2026/0353393 A1
(43) Pub. Date: Nov. 5, 2026

(54) METHOD AND DEVICE FOR SENDING UPLINK CHANNEL BASED ON CODEBOOK

(71) Applicant: Beijing Xiaomi Mobile Software Co., Ltd., Beijing (CN)

(72) Inventor: Zhenyu ZHANG, Beijing (CN)

(73) Assignee: Beijing Xiaomi Mobile Software Co., Ltd., Beijing (CN)

(21) Appl. No.: 19/115,739

(22) PCT Filed: Sep. 29, 2022
(86) PCT No.: PCT/CN2022/122777

§ 371 Date: Mar. 26, 2025

(51) Int. Cl. H04W 72/21; H04B 7/0456; H04B 7/06

(52) U.S. Cl. CPC H04W 72/21; H04B 7/0456; H04B 7/06952

(57) ABSTRACT

A method and system for uplink channel transmission based on a codebook is disclosed. A terminal device determines a codebook that matches the number of antenna ports used for uplink channel transmission, where the antenna ports share the same polarization direction. The terminal device then precodes the uplink channel using a codeword from the selected codebook and transmits the precoded uplink data channel to a network device. The codebook includes codeword sets for fully-coherent, partial-coherent, or non-coherent transmission. For fully-coherent transmission, the codeword set is generated based on a discrete Fourier transform (DFT) beam vector using dimensional information and oversampling factors of the antenna ports. Partial-coherent transmission is supported by grouping antenna ports based on port count and inter-group antenna correlation, while non-coherent transmission uses an antenna selection vector.

### CROSS-REFERENCE

The present application is a U.S. National Stage of International Application No. PCT/CN2022/122777, filed on Sep. 29, 2022, the contents of all of which are incorporated herein by reference in their entirety for all purposes.

### BACKGROUND OF THE INVENTION

In the 5^{th} generation mobile communication technology (5G) new radio (NR) system, a method for sending an uplink channel based on a codebook is a transmission method that determines spatial multiplexing of uplink channel precoding based on a fixed codebook, which is a common transmission method.

### SUMMARY OF THE INVENTION

The present disclosure relates to that technical field of communications, and in particular to a method and device for sending an uplink channel based on a codebook.

In an embodiment of a first aspect of the present disclosure, a method for sending an uplink channel based on a codebook is provided. The method is performed by a terminal device and includes: determining the codebook that matches a number of antenna ports used by the terminal device for sending the uplink channel, where there are a plurality of antenna ports for the uplink channel, and polarization directions of the plurality of antenna ports are same; precoding the uplink channel with a codeword in the codebook; and sending a precoded uplink data channel to a network device.

In an embodiment of a second aspect of the present disclosure, a method for sending an uplink channel based on a codebook is provided. The method is performed by a network device, and includes: receiving an uplink data channel that is precoded with a codeword in the codebook and sent by a terminal device, where the codebook matches a number of antenna ports used by the terminal device for sending the uplink channel, there are a plurality of antenna ports for the uplink channel, and polarization directions of the plurality of antenna ports are same.

In an embodiment of a third aspect of the present disclosure, a communication device is provided. The device includes one or more processors and a memory that stores a computer program, where the computer program, when collectively executed by the one or more processors, causes the communication device to: determine a codebook that matches a number of antenna ports used by the terminal device for sending an uplink channel, where there are a plurality of antenna ports for the uplink channel, and polarization directions of the plurality of antenna ports are same; precode the uplink channel with a codeword in the codebook; and send a precoded uplink data channel to a network device.

In an embodiment of a fourth aspect of the present disclosure, another communication device is provided. The device includes one or more processors and an interface circuit, where the interface circuit is configured to receive code instructions and send the code instructions to the one or more processors, and the one or more processors are configured to collectively execute the code instructions, to cause the communication device to perform the method for sending the uplink channel based on the codebook described in the embodiment of the first aspect.

In an embodiment of a fifth aspect of the present disclosure, a non-transitory computer-readable storage medium storing instructions is provided, where the instructions, when executed, implement the method for sending the uplink channel based on the codebook described in the embodiment of the first aspect.

In an embodiment of a sixth aspect of the present disclosure, a non-transitory computer-readable storage medium storing instructions is provided, where the instructions, when executed, implement the method for sending the uplink channel based on the codebook described in the embodiment of the second aspect.

Additional aspects and advantages of the present disclosure will be set forth in part from the following description, and in part will be apparent from the following description, or may be learned by practice of the present disclosure.

### BRIEF DESCRIPTION OF DRAWINGS

The above and/or additional aspects and advantages of the present disclosure will be obvious and easy to understand from the following description of embodiments taken in conjunction with the accompanying drawings, in which:

FIG. 1 is a schematic architecture diagram of a communication system according to an embodiment of the present disclosure;

FIG. 2 is a schematic flowchart of a method for sending an uplink channel based on a codebook according to an embodiment of the present disclosure;

FIG. 3 is a schematic flowchart of another method for sending the uplink channel based on the codebook according to an embodiment of the present disclosure;

FIG. 4(a) is a schematic diagram of an antenna arrangement of a terminal device according to an embodiment of the present disclosure;

FIG. 4(b) is a schematic diagram of another antenna arrangement of the terminal device according to an embodiment of the present disclosure;

FIG. 5 is a schematic flowchart of another method for sending the uplink channel based on the codebook according to an embodiment of the present disclosure;

FIG. 6 is a schematic flowchart of another method for sending the uplink channel based on the codebook according to an embodiment of the present disclosure;

FIG. 7 is a schematic flowchart of another method for sending the uplink channel based on the codebook according to an embodiment of the present disclosure;

FIG. 8 is a schematic flowchart of another method for sending the uplink channel based on the codebook according to an embodiment of the present disclosure;

FIG. 9 is a schematic structural diagram of a device for sending the uplink channel based on the codebook according to an embodiment of the present disclosure;

FIG. 10 is a schematic structural diagram of a device for sending the uplink channel based on the codebook according to an embodiment of the present disclosure;

FIG. 11 is a schematic structural diagram of a communication device according to an embodiment of the present disclosure; and

FIG. 12 is a schematic structural diagram of a chip according to an embodiment of the present disclosure.

### DETAILED DESCRIPTION OF THE INVENTION

Embodiments will be described in detail herein, examples of which are shown in the accompanying drawings. When the following description is made with reference to the accompanying drawings, the same numerals in different drawings represent the same or similar elements, unless otherwise indicated. The implementations described in the following examples do not represent all implementations consistent with the present disclosure. Rather, they are merely examples of the device and the method consistent with some aspects of the present disclosure as detailed in the appended claims.

The terms used in the embodiments of the present disclosure are for the purpose of describing specific embodiments only and are not intended to limit the embodiments of the present disclosure. The singular forms “a,” “an” and “the” used in the embodiments and the appended claims of present disclosure are also intended to include the plural forms, unless the context clearly indicates otherwise. It is also to be understood that the term “and/or” as used herein refers to and includes any or all possible combinations of one or more associated listed items.

It is to be understood that although the terms “first,” “second,” “third,” etc., may be used to describe various information in the embodiments of the present disclosure, such information should not be limited by these terms. These terms are merely used to distinguish the same type of information from each other. For example, without departing from the scope of the embodiments of the present disclosure, first information may be referred to as second information, and similarly, the second information may be referred to as the first information. Depending on the context, the words “in the event of” and “if” as used herein may be interpreted as “when” or “as” or “in response to determining”.

Embodiments of the present disclosure will be described below in detail. Examples of the embodiments are shown in the Figures, where same or similar reference numerals refer to same or similar elements from beginning to end. The embodiments described below with reference to the accompanying drawings are exemplary and are intended to explain the present disclosure, and should not be construed as limiting the present disclosure.

At present, to support a higher transmission rate of uplink comparable to that of downlink, it can be considered to expand the number of uplink sending antenna ports, e.g., four, while supporting the transmission with more than four layers. Therefore, how to perform the uplink transmission based on a codebook is one of key research issues in a case where the number of uplink sending antenna ports is expanded to several.

In order to better understand a method for sending an uplink channel based on a codebook disclosed in the embodiments of the present disclosure, a communication system applicable to the embodiments of the present disclosure will be described below.

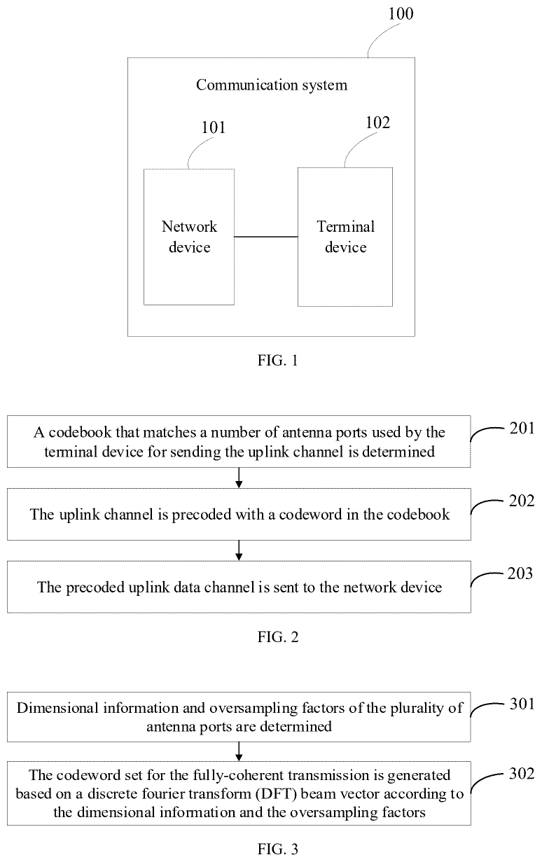

Referring to FIG. 1, FIG. 1 is a schematic architecture diagram of the communication system 100 according to an embodiment of the present disclosure. The communication system 100 may include, but is not limited to, a network device 101 and a terminal device 102. The number and form of devices shown in FIG. 1 are only for example and do not constitute a limitation to the embodiment of the present disclosure. In practical applications, two or more network devices and two or more terminal devices may be included. The communication system shown in FIG. 1 takes including a network device 101 and a terminal device 102 for example.

It should be noted that a technical solution of the embodiment of the present disclosure may be applied to various communication systems, for example, a long term evolution (LTE) system, a fifth generation mobile communication system, a 5G new radio system, or other novel mobile communication system in the future.

It can be understood that the communication system described in the embodiment of the present disclosure is intended to explain the technical solution provided in the embodiment of the present disclosure more clearly, and is not intended to limit the technical solution provided in the embodiment of the present disclosure. Those having ordinary skill in the art know that, with the evolution of system architectures and the emergence of new service scenarios, the technical solution provided in the embodiment of the present disclosure is also applicable to similar technical problems.

The network device 101 in the embodiment of the present disclosure is an entity at the network side for sending or receiving a signal. For example, the network device 101 may be an evolved nodeB (eNB), a transmission reception point (TRP), a next generation nodeB (gNB) in the NR system, a base station in other future mobile communication system or an access node in a wireless fidelity (Wi-Fi) system. In the embodiment of the present disclosure, the specific technology and the specific device form adopted by the network device are not limited. The network device provided in the embodiment of the present disclosure may consist of a central unit (CU) and a distributed unit (DU), where the CU may also be referred to as a control unit. With the structure of CU-DU, protocol layers of the network device, such as a base station, may be separated, functions of some protocol layers are placed in the CU for centralized control, while functions of remaining some or all protocol layers are distributed in the DU, and the CU centrally controls the DU.

The terminal device 102 in the embodiment of the present disclosure is an entity at the user side for receiving or sending a signal, such as a mobile phone. The terminal device can also be referred to as a terminal, a user equipment (UE), a mobile station (MS), a mobile terminal (MT), or the like. The terminal device may be a car with a communication function, a smart car, a mobile phone, a wearable device, a Pad, a computer with a wireless transceiving function, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, or the like. In the embodiment of the present disclosure, the specific technology and the specific device form adopted by the terminal device are not limited.

In the 5th generation mobile communication technology (5G) new radio (NR) system, a method for uplink sending based on the codebook is a transmission method that determines spatial multiplexing of uplink channel precoding based on a fixed codebook, which is a common transmission method.

In physical uplink shared channel (PUSCH) transmission based on the codebook in NR, the terminal device needs to configure at most one sounding reference signal (SRS) resource set for uplink transmission based on the codebook, and the SRS resource set may be configured with a plurality of SRS resources (N_{SRS} SRS resources). The network side may provide feedback on an SRS resource indicator (SRI) with a log₂(N_{SRS}) bit and select an SRS resource via the SRI. Similarly, the network device finally determines a transmission precoding matrix indicator (TPMI) and a rank indicator (RI) used by the terminal for actual transmission, based on the measurement of uplink channel state information (CSI), and informs the terminal of the TPMI and the RI. The data for the subsequent uplink transmission used by the terminal device needs to be precoded with a precoding matrix specified by the network device, and a precoded data is mapped to a corresponding antenna port based on a spatial filter corresponding to an SRS resource indicated by the SRI. Different SRSs may be transmitted via different spatial filters, so the precoded data of the terminal needs to be filtered by a spatial filter used by an SRS indicated by the SRI. In this way, the transmission of uplink data from a single layer to a full rank can be supported.

In a 5G NR uplink multiple input multiple output (MIMO) system, the maximum number of antenna ports supported by the system is four, and only a dual-polarized antenna is supported. Therefore, there is only one antenna arrangement, of which a dimension is (M,N,P)=(1,2,2), a dual-polarized antenna pair with one row and two columns. The communication system defines three types of coherent transmissions of the UE: fully-coherent transmission among all antennas, partial-coherent transmission among some antennas and non-coherent transmission among antennas. Therefore, the codebook design for uplink transmission needs to support three types of the codeword, which are a codeword for the fully-coherent transmission among all antennas, a codeword for the partial-coherent transmission among some antennas and a codeword for the non-coherent transmission among antennas. In the protocol Rel-15, the uplink supports up to four ports and supports transmission with up to four layers. Therefore, a maximum dimension of a corresponding codebook matrix is 4*4.

In order to support a higher transmission rate of uplink comparable to that of downlink, it can be considered to expand a maximum number of antenna ports supported by each UE for the MIMO uplink transmission from four (for example, to eight), and meanwhile, a single-polarized antenna and transmission with more than four layers can be supported. Therefore, in a case that there are a plurality of antenna ports for uplink sending and polarization directions of antennas are same, how to determine a codebook that matches antenna ports used by the terminal device for sending the uplink channel needs to be considered.

In view of the above problems, a method and device for sending the uplink channel based on the codebook are provided in the present disclosure.

The method and device for sending the uplink channel based on the codebook provided in the present disclosure will be described below in detail in conjunction with the accompanying drawings.

FIG. 2 is a schematic flowchart of the method for sending the uplink channel based on the codebook according to an embodiment of the present disclosure. It should be noted that the method in the embodiment of the present disclosure is performed by a terminal device. As shown in FIG. 2, the method for sending the uplink channel based on the codebook includes the following steps.
Step 201, a codebook that matches a number of antenna ports used by the terminal device for sending the uplink channel is determined.

Where there are a plurality of antenna ports for the uplink channel, and polarization directions of the plurality of antenna ports are same.

In the embodiment of the present disclosure, the terminal device may determine a codebook that matches a number of its own antenna ports. The codebook may include at least one codeword or a codeword set.

For example, when the number of antenna ports used by the terminal device for sending the uplink channel is eight, and the uplink transmission based on the codebook with up to eight layers may be supported, the terminal device may determine a codebook that matches the number of its own antenna ports, that is, a codebook for eight ports.

There are the plurality of antenna ports for the uplink channel, and polarization directions of the plurality of antenna ports are same. For example, there are eight antenna ports used by the terminal device for sending the uplink channel, and polarization directions of the eight antenna ports are same, for example, the polarization directions of the eight antenna ports are vertical polarization; and for another example, the polarization directions of the eight antenna ports are horizontal polarization or other polarization directions.

It should be understood that the terminal device may not calibrate all antenna ports for coherent transmission. The NR system defines three types of antenna coherent transmission capabilities of the terminal: full coherent: coherent transmission may be performed via all antenna ports of the terminal device; partial-coherent: coherent transmission may be performed via antenna ports in the same coherent transmission group of the terminal device, and coherent transmission cannot be performed via antenna ports in different coherent transmission groups; and non-coherent: coherent transmission cannot be performed via antenna ports of the terminal device. Therefore, in the embodiment of the present disclosure, the codebook for the uplink transmission may support corresponding three types of the codeword (codeword matrices), and the terminal device may determine a codebook that matches the number of its own antenna ports, which may include at least one of: a codeword set for fully-coherent transmission, the codeword set for partial-coherent transmission or the codeword set for non-coherent transmission.

It should be understood that the codeword in the present disclosure may refer to a precoding matrix, and the codebook may be a collection of one or more codewords, or one or more precoding matrices.
Step 202, the uplink channel is precoded with a codeword in the codebook.

As a possible implementation of the embodiment of the present disclosure, the terminal device may select an indicated codeword from the codebook to precode the uplink channel based on the indication information sent by the network device.

For example, the indication information sent by the network device may include at least one of a transmission precoding matrix indicator (TPMI) or a sounding reference signal (SRS) resource indicator (SRI).

That is, optionally, the terminal device may determine a corresponding codeword from the codebook based on the TPMI sent by the network device, and may further determine a corresponding codeword from the codebook based on the TPMI and SRI sent by the network device. Furthermore, the terminal device may precode the uplink channel with the determined codeword to complete transmission of the uplink channel.
Step 203, the precoded uplink data channel is sent to the network device.

Thus, the terminal device may map the precoded data to the corresponding antenna port and send the precoded uplink data channel to the network device.

In the embodiment of the present disclosure, the uplink data channel may be the PUSCH.

To sum up, the codebook that matches the number of antenna ports used by the terminal device for sending the uplink channel is determined, where there are the plurality of antenna ports for the uplink channel, and the polarization directions of the plurality of antenna ports are same; the uplink channel is precoded with the codeword in the codebook; and the precoded uplink data channel is sent to the network device. Thus, in a case that there are the plurality of antenna ports for uplink sending and polarization directions of the plurality of antenna ports for the uplink sending are same, the codebook that matches the number of antenna ports used by the terminal device for sending the uplink channel may be determined, and the uplink data channel that is precoded with the codeword in the codebook can be sent to the network device. Performing uplink transmission based on the codebook can realize spatial multiplexing of uplink channel precoding, which effectively increases the rate of uplink channel transmission, and enhances the communication efficiency.

Another method for sending the uplink channel based on the codebook is provided in an embodiment of the present disclosure. FIG. 3 is a schematic flowchart of another method for sending the uplink channel based on the codebook according to an embodiment of the present disclosure. The method may be performed by the terminal device. The method for sending the uplink channel based on the codebook may be performed alone, in conjunction with any embodiment or possible implementation in the embodiment of the present disclosure, or in conjunction with any technical solution in the related art.

As shown in FIG. 3, the method for sending the uplink channel based on the codebook may include the following steps.
Step 301, dimensional information and oversampling factors of the plurality of antenna ports are determined.

In the embodiment of the present disclosure, the plurality of antenna ports may have various dimensional information, where each dimensional information may support a plurality of groups of oversampling factors. Each group of the oversampling factors may include an oversampling coefficient O₁ of a first dimension in corresponding dimensional information in an antenna array and an oversampling coefficient O₂ of a second dimension in the corresponding dimensional information.

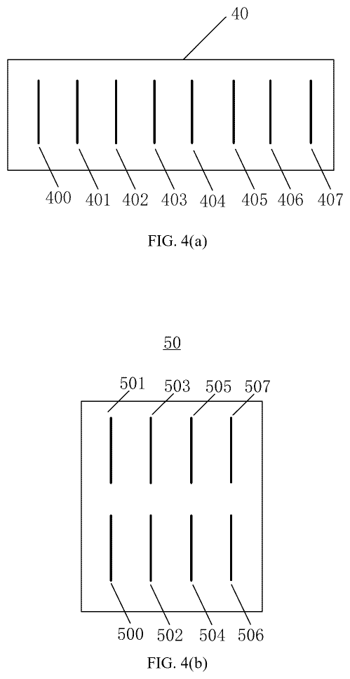

For example, the number of antenna ports is eight. A single panel antenna array 40 is shown in FIG. 4(a). In the single panel antenna array 40, the antenna ports include antenna ports 400-407, the number of antenna ports on the first dimension in the same polarization direction is eight (N₁=8), and the number of antenna ports on the second dimension in the same polarization direction is one (N₂=1). Alternatively, a single panel antenna array 50 is shown in FIG. 4(b). In the single panel antenna array 50, the antenna ports include antenna ports 500-507, the number of antenna ports on the first dimension in the same polarization direction is four (N₁=4), and the number of antenna ports on the second dimension in the same polarization direction is two (N₂=2). The dimensional information of the eight antenna ports and the plurality of groups of the oversampling factors supported by each piece of dimensional information may be as shown in Table 1, in which the correspondences between dimensional information of the eight antenna ports and supported oversampling factors are indicated.

TABLE 1

| Number of | | | | |
|---|---|---|---|---|
| CSI-RS | | | | |
| antenna ports | (N₁, N₂) | (O₁, O₂) | (O₁, O₂) | (O₁, O₂) |
| 8 | (4, 2) | (4, 4) | (2, 2) | (1, 1) |
| | (8, 1) | (4, 1) | (2, 1) | (1, 1) |

It may be understood that each element and each correspondence in Table 1 exist independently. These elements and correspondences are exemplarily listed in the same table. However, it does not mean that all elements and correspondences in the table must exist at the same time as shown in Table 1. The value of each element and each correspondence are independent of any other element value or correspondence in Table 1. Therefore, those having ordinary skill in the art may understand that the value of each element or each correspondence in Table 1 is an independent embodiment.

Step 302, the codeword set for the fully-coherent transmission is generated based on a discrete Fourier transform (DFT) beam vector according to the dimensional information and the oversampling factors.

In the embodiment of the present disclosure, the DFT beam vector corresponding to each layer codeword may be determined based on the dimensional information and the oversampling factors, and then, the each layer codeword may be determined based on the DFT beam vector corresponding to the each layer codeword, and the codeword set for the fully-coherent transmission may be generated based on the each layer codeword.

To sum up, the dimensional information and the oversampling factors of the plurality of antenna ports are determined, and the codeword set for the fully-coherent transmission is generated based on the DFT beam vector according to the dimensional information and the oversampling factors. Thus, the codeword set for the fully-coherent transmission may be generated based on the DFT beam vector, according to the dimensional information and the oversampling factors of the plurality of antenna ports.

Another method for sending the uplink channel based on the codebook is provided in an embodiment of the present disclosure. FIG. 5 is a schematic flowchart of another method for sending the uplink channel based on the codebook according to an embodiment of the present disclosure. The method may be performed by a terminal device. The method for sending the uplink channel based on the codebook may be performed alone, in conjunction with any embodiment or possible implementation in the embodiment of the present disclosure, or in conjunction with any technical solution in the related art.

As shown in FIG. 5, the method for sending the uplink channel based on the codebook may include the following steps.
Step 501, dimensional information and oversampling factors of the plurality of antenna ports are determined.
Step 502, first indication information and second indication information are determined.

Where the first indication information and the second indication information are configured to indicate a DFT beam corresponding to a first layer codeword.

In an embodiment of the present disclosure, the first indication information and the second indication information may be determined according to the dimensional information and the oversampling factors of the plurality of antenna ports, where the first indication information and the second indication information are configured to indicate a DFT beam corresponding to the first layer codeword.

In the embodiment of the present disclosure, the DFT beam vector may be same as a codebook beam vector, and the calculation formula may be as follows:

$${u}_{m} = \{ \begin{matrix}[ 1 {e}^{j \frac{2 π m}{{O}_{2} {N}_{2}}} … {e}^{j \frac{2 π m ( {N}_{2} - 1 )}{{O}_{2} {N}_{2}}} ] & {N}_{2} > 1 \\ 1 & {N}_{2} = 1\end{matrix} ;$$

$${v}_{l , m} = {[ {u}_{m} {e}^{j \frac{2 π l}{{O}_{1} {N}_{1}}} {u}_{m} … {e}^{j \frac{2 π l ( {N}_{1} - 1 )}{{O}_{1} {N}_{1}}} {u}_{m} ]}^{T} ;$$

It should be noted that the DFT beam (beam vector) corresponding to the first layer codeword is V_{l,m}, where l may be indicated by first indication information i_{1,1}, and m may be indicated by second indication information i_{1,2}, where (i_{1,1}=0, 1, . . . , N₁O₁−1, i_{1,2}=0, 1, . . . , N₂O₂−1, N₁ represents the number of antenna ports on the first dimension in the same polarization direction, N₂ represents the number of antenna ports on the second dimension in the same polarization direction, and O₁, and O₂ represent a group of the oversampling factors supported by dimensions (N₁, N₂) of the plurality of antenna ports.
Step 503, third indication information is determined.

Where the third indication information is configured to indicate an offset of a beam index of other layer codeword relative to a beam index of the first layer codeword under the dimensional information.

For example, the offset of the beam index of the other layer codeword relative to the beam index of the first layer codeword under the dimensional information of the antenna ports, that is, a beam vector Vₗ_{^{(k)}}_{,m}_{^{(k)}} selected by the other layer codeword, where l^{(k)} is indicated by a beam index i_{1,1}+k₁ of the first layer codeword, m^{(k)} is indicated by a beam index i_{1,2}+k₂ of the first layer codeword, where k represents a number of layers of the codeword, k₁ and k₂ represent the offset of the beam index of the other layer codeword relative to the beam index of the first layer codeword, and k₁ and k₂ may be indicated by third indication information i₄. It should be noted that a maximum value of k₁ may be (N₁−1)O₁, and a maximum value of k₂ may be (N₂−1)O₂. For example, the number of antenna ports is eight, maximum values of the offsets k₁ and k₂ indicated by the third indication information (i₄) in different antenna dimensions (N₁, N₂) may be as shown in Table 2, in which correspondences between the antenna dimensions of the eight antenna ports and the maximum values of the offsets are indicated.

TABLE 2

| | | N₁ = 4, N₂ = 2 | | N₁ = 8, N₂ = 1 | |
|---|---|---|---|---|---|
| k | i₄ | k₁ | k₂ | k₁ | k₂ |
| 1 | 0 | 0 | 0 | 0 | 0 |
| 2 | 1 | O₁ | 0 | O₁ | 0 |
| 3 | 2 | 0 | O₂ | 2O₁ | 0 |
| 4 | 3 | O₁ | O₂ | 3O₁ | 0 |
| 5 | 4 | 2O₁ | 0 | 4O₁ | 0 |
| 6 | 5 | 2O₁ | O₂ | 5O₁ | 0 |
| 7 | 6 | 3O₁ | 0 | 6O₁ | 0 |
| 8 | 7 | 3O₁ | O₂ | 7O₁ | 0 |

It can be understood that each element and each correspondence in Table 2 exist independently. These elements and correspondences are exemplarily listed in the same table. However, it does not mean that all elements and correspondences in the table must exist at the same time as shown in Table 2. The value of each element and each correspondence are independent of any other element value or correspondence in Table 2. Therefore, those having ordinary skill in the art can understand that the value of each element or each correspondence in Table 2 is an independent embodiment.
Step 504, a DFT beam corresponding to the other layer codeword is determined based on the third indication information.

In the embodiment of the present disclosure, the DFT beam corresponding to the other layer codeword may be determined based on the offset of the beam index of the other layer codeword relative to the beam index of the first layer codeword under the dimensional information indicated by the third indication information.
Step 505, the codeword set for the fully-coherent transmission is determined based on at least one of the first layer codeword or the other layer codeword.

For example, let W^{k}=ₗ_{^{(k)}}_{,m}_{^{(k)}} represent a k-th layer codeword, L layers codeword

$${W}_{8 Tx}^{L}$$

for the eight ports are constructed as

$${W}_{8 Tx}^{L} = [ {W}^{1} {W}^{2} … {W}^{L} ] .$$

In the embodiment of the present disclosure, step 501 may be performed in any of manners in various embodiments of the present disclosure, which will not be limited in the embodiments of the present disclosure and will not be repeated here.

To sum up, the dimensional information and the oversampling factors of the plurality of antenna ports are determined; the first indication information and the second indication information are determined, where the first indication information and the second indication information are configured to indicate the DFT beam corresponding to the first layer codeword, and the third indication information is determined, where the third indication information is configured to indicate the offset of the beam index of the other layer codeword relative to the beam index of the first layer codeword under the dimensional information. Therefore, the first indication information, the second indication information and the third indication information are determined through the dimensional information and the oversampling factors of the plurality of antenna ports, and the beam vector corresponding to the each layer codeword are determined through the first indication information, the second indication information and the third indication information, so that the each layer codeword may be determined based on the beam vector corresponding to the each layer codeword, and then the codeword set for the fully-coherent transmission may be generated based on the each layer codeword.

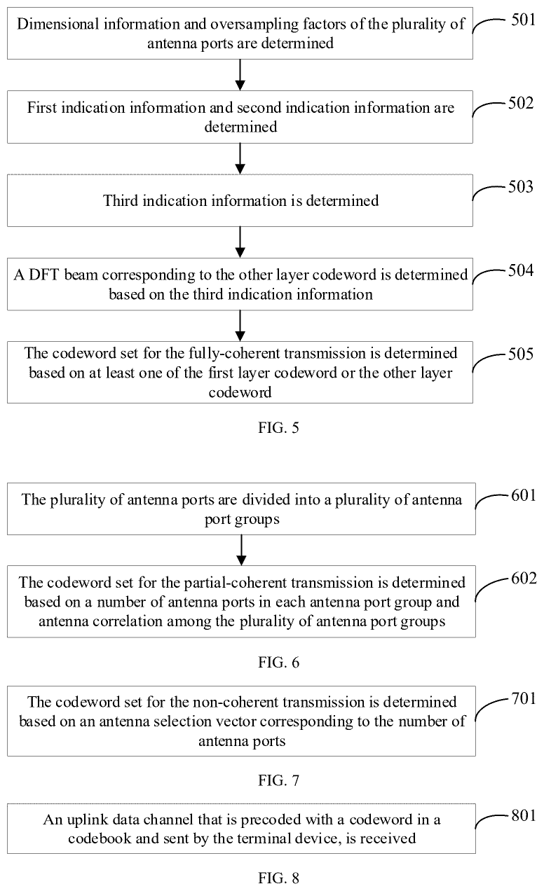

Another method for sending the uplink channel based on the codebook is provided in an embodiment of the present disclosure. FIG. 6 is a schematic flowchart of another method for sending the uplink channel based on the codebook according to an embodiment of the present disclosure. The method may be performed by a terminal device. The method for sending the uplink channel based on the codebook may be performed alone, in conjunction with any embodiment or possible implementation in the embodiment of the present disclosure, or in conjunction with any technical solution in the related art.

As shown in FIG. 6, the method for sending the uplink channel based on the codebook may include the following steps.
Step 601, the plurality of antenna ports are divided into a plurality of antenna port groups.

For example, when eight antenna ports are used for partial-coherent transmission, the eight antenna ports may be divided into two antenna port groups or four antenna port groups.
Step 602, the codeword set for the partial-coherent transmission is determined based on a number of antenna ports in each antenna port group and antenna correlation among the plurality of antenna port groups.

In the embodiment of the present disclosure, different antenna port groups and the antenna correlation among the plurality of antenna port groups correspond to different manners in which the codeword set for the partial-coherent transmission is determined.

For example, there are two antenna port groups, the first antenna port group includes ports {0,1,2,3}, and the second antenna port group includes ports {4,5,6,7}. Single-polarized codeword for four ports may be set with reference to Table 2, and maximum values of offsets k₁ and k₂ indicated by third indication information (i₄) on various antenna dimensions (N₁, N₂) of the single-polarized codeword for the four ports may be as shown in Table 3, in which the correspondences between the various antenna dimensions of the single-polarized codebook for the four ports and the maximum values of the offsets are indicated.

TABLE 3

| | | N₁ = 4, N₂ = 1 | | N₁ = 2, N₂ = 2 | |
|---|---|---|---|---|---|
| k | i₄ | k₁ | k₂ | k₁ | k₂ |
| 1 | 0 | 0 | 0 | 0 | 0 |
| 2 | 1 | O₁ | 0 | O₁ | 0 |
| 3 | 2 | 2O₁ | 0 | 0 | O₂ |
| 4 | 3 | 3O₁ | 0 | O₁ | O₂ |

It can be understood that each element and each correspondence in Table 3 exist independently. These elements and correspondences are exemplarily listed in the same table. However, it does not mean that all elements and correspondences in the table must exist at the same time as shown in Table 3. The value of each element and each correspondence are independent of any other element value or correspondence in Table 3. Therefore, those having ordinary skill in the art can understand that the value of each element or each correspondence in Table 3 is an independent embodiment.

It should be noted that L layers codeword

$${W}_{4 Tx}^{L}$$

for the four ports may be constructed

$${W}_{4 Tx}^{L} = [ {W}^{1} {W}^{2} … {W}^{L} ] .$$

Therefore, eight layers partial-coherent codeword for the eight ports may be designed as

$${W}_{8 Tx}^{L} = [ \begin{matrix}{W}_{4 Tx}^{L} & 0 \\ 0 & φ {W}_{4 Tx}^{L}\end{matrix} ] ,$$

where φ represents a co-phase coefficient, and φ∈{+1,−1, +j,−j}, j=\sqrt{−1}. When the number of layers is less than eight, any L columns are selected from the eight layers codeword, and an absolute value of a difference between a number of columns selected from first four layers and a number of columns selected from last four layers is less than or equal to 1. For example, if six columns are selected from the eight layers codeword, the number of columns selected from the first four layers may be three, the number of columns selected from the last four layers may be three, and the absolute value of the difference between the number of columns selected from the first four layers and the number of columns selected from the last four layers is equal to 0.

For another example, if there are four antenna port groups, two cases can be considered. The first case is that two port groups are coherent, and the other two port groups are coherent. The second case is that three port groups are coherent, and the other one is coherent.

In a first case, assuming that the first port group and the third port group are coherent, and the second port group and the fourth port group are coherent, the codeword set for the partial-coherent transmission may be shown as follows:

$${W}_{8 Tx}^{L} = [ \begin{matrix}{W}_{2 Tx}^{L} & 0 \\ 0 & {W}_{2 Tx}^{L} \\ φ {W}_{2 Tx}^{L} & 0 \\ 0 & φ {W}_{2 Tx}^{L}\end{matrix} ]$$

$$or {W}_{8 Tx}^{L} = [ \begin{matrix}{W}_{4 Tx}^{L} ( 1 : 2 ) & 0 \\ 0 & {W}_{4 Tx}^{L} ( 1 : 2 ) \\ φ {W}_{4 Tx}^{L} ( 3 : 4 ) & 0 \\ 0 & φ {W}_{4 Tx}^{L} ( 3 : 4 )\end{matrix} ]$$

$$where {W}_{4 Tx}^{L} ( a : b )$$

represents row a to row b of

$${W}_{4 Tx}^{L} .$$

Assuming that the first port group and the second port group are coherent, and the third port group and the fourth port group are coherent, the codeword set for the partial-coherent transmission may be shown as follows:

$${W}_{8 Tx}^{L} = [ \begin{matrix}{W}_{2 Tx}^{L} & 0 \\ φ {W}_{2 Tx}^{L} & 0 \\ 0 & {W}_{2 Tx}^{L} \\ 0 & φ {W}_{2 Tx}^{L}\end{matrix} ] or$$

$${W}_{8 Tx}^{L} = [ \begin{matrix}{W}_{4 Tx}^{L} ( 1 : 2 ) & 0 \\ φ {W}_{4 Tx}^{L} ( 3 : 4 ) & 0 \\ 0 & {W}_{4 Tx}^{L} ( 1 : 2 ) \\ 0 & φ {W}_{4 Tx}^{L} ( 3 : 4 )\end{matrix} ] , where {W}_{4 Tx}^{L} ( a : b )$$

represents row a to row b of

$${W}_{4 Tx}^{L} .$$

In a second case, assuming that the first port group, the second port group and the third port group are coherent, the codeword set for partial-coherent transmission may be shown as follows.

$${W}_{8 Tx}^{L} = [ \begin{matrix}{W}_{2 Tx}^{L} & 0 \\ 0 & {W}_{6 Tx}^{L}\end{matrix} ] .$$

To sum up, the plurality of antenna ports are divided into the plurality of antenna port groups; and the codeword set for the partial-coherent transmission is determined based on the number of antenna ports in each antenna port group and the antenna correlation among the plurality of antenna port groups. Thus, the codeword set for the partial-coherent transmission may be determined based on the number of antenna ports in each antenna port group and the antenna correlation among the plurality of antenna port groups.

An embodiment of the present disclosure provides another method for sending the uplink channel based on the codebook. FIG. 7 is a schematic flowchart of another method for sending the uplink channel based on the codebook according to an embodiment of the present disclosure. The method may be performed by the terminal device. The method for sending the uplink channel based on the codebook may be performed alone, in conjunction with any embodiment or possible implementation in the embodiment of the present disclosure, or in conjunction with any technical solution in the related art. As shown in FIG. 7, the method for sending the uplink channel based on the codebook may include the following step.
Step 701: the codeword set for the non-coherent transmission is determined based on an antenna selection vector corresponding to the number of antenna ports.

Where the antenna selection vector is configured to map a signal to corresponding antenna ports, for example, one layer codeword for the eight antenna ports, such as [1 0 0 0 0 0 0 0]^{T} or [0 0 1 0 0 0 0 0]^{T}, where T represents a transposed matrix, and each layer is mapped only at one corresponding antenna port.

For example, when the number of antenna ports is eight, which is the same as that of the dual-polarized codeword, an 8*1 antenna selection vector may be used for the non-coherent codeword, and when the number of layers is L, the number of codewords is

$${C}_{8}^{L} .$$

For example, when the number of layers is one, the non-coherent codeword may be as shown in Table 4, in which one layer single-polarized non-coherent codeword for the eight antenna ports are indicated.

TABLE 4

| | | | | | | | |
|---|---|---|---|---|---|---|---|
| $[ \begin{matrix}1 \\ 0 \\ 0 \\ 0 \\ 0 \\ 0 \\ 0 \\ 0\end{matrix} ]$ | $[ \begin{matrix}0 \\ 1 \\ 0 \\ 0 \\ 0 \\ 0 \\ 0 \\ 0\end{matrix} ]$ | $[ \begin{matrix}0 \\ 0 \\ 1 \\ 0 \\ 0 \\ 0 \\ 0 \\ 0\end{matrix} ]$ | $[ \begin{matrix}0 \\ 0 \\ 0 \\ 1 \\ 0 \\ 0 \\ 0 \\ 0\end{matrix} ]$ | $[ \begin{matrix}0 \\ 0 \\ 0 \\ 0 \\ 1 \\ 0 \\ 0 \\ 0\end{matrix} ]$ | $[ \begin{matrix}0 \\ 0 \\ 0 \\ 0 \\ 0 \\ 1 \\ 0 \\ 0\end{matrix} ]$ | $[ \begin{matrix}0 \\ 0 \\ 0 \\ 0 \\ 0 \\ 0 \\ 1 \\ 0\end{matrix} ]$ | $[ \begin{matrix}0 \\ 0 \\ 0 \\ 0 \\ 0 \\ 0 \\ 0 \\ 1\end{matrix} ]$ |

It can be understood that each element and each correspondence in Table 4 exist independently. These elements and correspondences are exemplarily listed in the same table. However, it does not mean that all elements and correspondences in the table must exist at the same time as shown in Table 4. The value of each element and each correspondence are independent of any other element value or correspondence in Table 4. Therefore, those having ordinary skill in the art can understand that the value of each element or each correspondence in Table 4 is an independent embodiment.

It should be noted that energy normalization is not performed on the codeword design in Table 4. When energy normalization is performed on the codeword, the codeword may be multiplied by a set energy normalization factor.

Optionally, the energy normalization factor may be set to the arithmetic square root of the reciprocal of a number of non-zero elements in the matrix.

To sum up, the codeword set for the non-coherent transmission is determined based on the antenna selection vector corresponding to the number of antenna ports. Thus, the codeword set for the non-coherent transmission may be determined.

According to the device for sending the uplink channel based on the codebook device provided in the embodiment of the present disclosure, the codebook that matches the number of antenna ports used by the terminal device for sending the uplink channel is determined, where there are the plurality of antenna ports for the uplink channel, and polarization directions of the plurality of antenna ports are same; the uplink channel is precoded with the codeword in the codebook; and the precoded uplink data channel is sent to the network device. Thus, in a case that there are a plurality of antenna ports for the uplink sending and polarization directions of the plurality of antenna ports for the uplink sending are same, the codebook that matches the number of antenna ports used by the terminal device for sending the uplink channel can be determined, and the uplink data channel that is precoded with the codeword in the codebook can be sent to the network device. Performing uplink transmission based on a codebook can realize spatial multiplexing of uplink channel precoding, which effectively increases the rate of uplink channel transmission, and enhances the communication efficiency.

An embodiment of the present disclosure provides another method for sending the uplink channel based on the codebook. FIG. 8 is a schematic flowchart of another method for sending an uplink channel based on the codebook according to an embodiment of the present disclosure. The method may be performed by a network device. The method for sending the uplink channel based on the codebook may be performed alone, in conjunction with any embodiment or possible implementation in the embodiment of the present disclosure, or in conjunction with any technical solution in the related art. As shown in FIG. 8, the method for sending the uplink channel based on the codebook may include the following step.
Step 801, an uplink data channel that is precoded with a codeword in a codebook and sent by the terminal device, is received.

Where the codebook matches a number of antenna ports used by the terminal device for sending the uplink channel, there are a plurality of antenna ports for the uplink channel, and polarization directions of the plurality of antenna ports are same.

In the embodiment of the present disclosure, the terminal device may determine the codebook that matches a number of its own antenna ports, where there are the plurality of antenna ports for the uplink channel, and the polarization directions of the plurality of antenna ports are same; the terminal device may select an indicated codeword from the codebook to precode the uplink channel based on the indication information sent by the network device, and may map precoded data to a corresponding antenna port and send the precoded uplink data channel to the network device. Thus, the network device may receive the uplink data channel precoded with the codeword in the codebook, which is sent by the terminal device.

To sum up, the uplink data channel, which is precoded with the codeword in the codebook and sent by the terminal device, is received. In a case that there are the plurality of antenna ports for uplink sending and polarization directions of the plurality of antenna ports are same, the terminal device may determine the codebook that matches the number of antenna ports used by the terminal device for the uplink channel and send the uplink data channel precoded with the codeword in the codebook to the network device. The network device may receive the uplink data channel that is precoded with the codeword in the codebook and sent by the terminal device. Performing uplink transmission based on the codebook can realize spatial multiplexing of uplink channel precoding, which effectively increases the rate of uplink channel transmission, and enhances the communication efficiency.

In some implementations, the codebook includes at least one of: a codeword set for fully-coherent transmission; the codeword set for partial-coherent transmission; or the codeword set for non-coherent transmission.

As a possible implementation of the embodiment of the present disclosure, the codeword set for the fully-coherent transmission is generated based on a discrete Fourier transform (DFT) beam vector according to dimensional information and oversampling factors of the plurality of antenna ports.

As a possible implementation of the embodiment of the present disclosure, the codeword set for the fully-coherent transmission is determined based on at least one of a first layer codeword or other layer codeword; the first layer codeword is determined based on the first indication information and the second indication information, where the first indication information and the second indication information are configured to indicate a DFT beam corresponding to the first layer codeword; and a DFT beam corresponding to the other layer codeword is determined based on third indication information, where the third indication information is configured to indicate an offset of a beam index of the other layer codeword relative to a beam index of the first layer codeword under the dimensional information.

As a possible implementation of the embodiment of the present disclosure, each of at least one piece of dimensional information of the plurality of antenna ports supports a plurality of groups of the oversampling factors.

As a possible implementation of the embodiment of the present disclosure, the codeword set for the partial-coherent transmission is determined based on a number of antenna ports in each antenna port group of a plurality of antenna port groups and antenna correlation among the plurality of antenna port groups, where the plurality of antenna port groups are divided based on the plurality of antenna ports.

As a possible implementation of the embodiment of the present disclosure, the codeword set for the non-coherent transmission is determined based on an antenna selection vector corresponding to the number of antenna ports.

According to the method for sending the uplink channel based on the codebook provided in the embodiment of the present disclosure, the uplink data channel, which is precoded with the codeword in the codebook and sent by the terminal device, is received. In a case that there are the plurality of antenna ports for the uplink sending and polarization directions of the plurality of antenna ports are same, the terminal device may determine the codebook that matches the number of antenna ports used by the terminal device for sending the uplink channel and send the uplink data channel precoded with the codeword in the codebook to the network device. The network device may receive the uplink data channel that is precoded with the codeword in the codebook and sent by the terminal device. Performing uplink transmission based on the codebook can realize spatial multiplexing of uplink channel precoding, which effectively increases the rate of uplink channel transmission, and enhances the communication efficiency.

In the above embodiment provided by the present disclosure, the methods provided in the embodiment of the present disclosure is introduced from the perspectives of the network device and the terminal device respectively. In order to implement various functions in the method provided in the embodiment of the present disclosure, the network device and the terminal device may include hardware structures and software modules, and the above functions are implemented in the form of hardware structures, software modules, or a combination of hardware structures and software modules. One of the above functions may be performed in a hardware structure, a software module, or a combination of the hardware structure and the software module.

Corresponding to the method for sending the uplink channel based on the codebook provided in the above embodiments of FIGS. 2-7, a device for sending the uplink channel based on the codebook is further provided in the present disclosure. Since the device for sending the uplink channel based on the codebook provided in the embodiment of the present disclosure corresponds to the method provided in the above embodiments, the implementations of the method for sending the uplink channel based on the codebook are also applicable to the device for sending the uplink channel based on the codebook provided in the embodiment, which will not be described in detail in the embodiment.

FIG. 9 is a schematic structural diagram of a device for sending the uplink channel based on the codebook according to an embodiment of the present disclosure. The device is applied to a terminal device.

As shown in FIG. 9, a device 900 for sending the uplink channel based on the codebook includes a processing unit 910 and a first transceiving unit 920, where:
the processing unit 910, is configured to determine a codebook that matches a number of antenna ports used by the terminal device for sending the uplink channel, where there are a plurality of antenna ports for the uplink channel, and polarization directions of the plurality of antenna ports are same; and the processing unit 910 is further configured to precode the uplink channel with a codeword in the codebook; and the first transceiving unit 920, is configured to send a precoded uplink data channel to a network device.

As a possible implementation of the embodiment of the present disclosure, the codebook includes at least one of: a codeword set for fully-coherent transmission; the codeword set for partial-coherent transmission; or the codeword set for non-coherent transmission.

As a possible implementation of the embodiment of the present disclosure, the processing unit 910 is further configured to determine dimensional information and oversampling factors of the plurality of antenna ports; and generate the codeword set for the fully-coherent transmission based on a discrete Fourier transform (DFT) beam vector according to the dimensional information and the oversampling factors.

As a possible implementation of the embodiment of the present disclosure, the processing unit 910 is further configured to determine first indication information and second indication information, where the first indication information and the second indication information are configured to indicate a DFT beam corresponding to a first layer codeword; determine third indication information, where the third indication information is configured to indicate an offset of a beam index of other layer codeword relative to a beam index of the first layer codeword under the dimensional information; determine a DFT beam corresponding to the other layer codeword based on the third indication information; and determine the codeword set for the fully-coherent transmission based on at least one of the first layer codeword or the other layer codeword.

As a possible implementation of the embodiment of the present disclosure, each of at least one piece of dimensional information of the plurality of antenna ports supports a plurality of groups of the oversampling factors.

As a possible implementation of the embodiment of the present disclosure, the processing unit 910 is further configured to divide the plurality of antenna ports into a plurality of antenna port groups; and determine the codeword set for the partial-coherent transmission based on a number of antenna ports in each antenna port group and antenna correlation among the plurality of antenna port groups.

As a possible implementation of the embodiment of the present disclosure, the processing unit 910 is further configured to determine the codeword set for the non-coherent transmission based on an antenna selection vector corresponding to the number of antenna ports.

According to the device for sending the uplink channel based on the codebook provided in the embodiment of the present disclosure, the codebook that matches the number of antenna ports used by the terminal device for sending the uplink channel is determined, where there are the plurality of antenna ports for the uplink channel, and polarization directions of the plurality of antenna ports are same; the uplink channel is precoded with the codeword in the codebook; and the precoded uplink data channel is sent to the network device. Thus, in a case that there are a plurality of antenna ports for the uplink sending and the polarization directions of the plurality of antenna ports for the uplink sending are same, the codebook that matches the number of antenna ports used by the terminal device for sending the uplink channel can be determined, and the uplink data channel that is precoded with the codeword in the codebook can be sent to the network device. Performing uplink transmission based on the codebook can realize spatial multiplexing of uplink channel precoding, which effectively increases the rate of uplink channel transmission, and enhances the communication efficiency.

Corresponding to the method for sending the uplink channel based on the codebook provided in the above embodiment of FIG. 8, a device for sending the uplink channel based on the codebook is further provided in the present disclosure. Since the device for sending the uplink channel based on the codebook provided in the embodiment of the present disclosure corresponds to the methods provided in the above embodiments, the implementations of the method for sending the uplink channel based on the codebook are also applicable to the device for sending the uplink channel based on the codebook provided in the embodiment, which will not be described in detail in the embodiment.

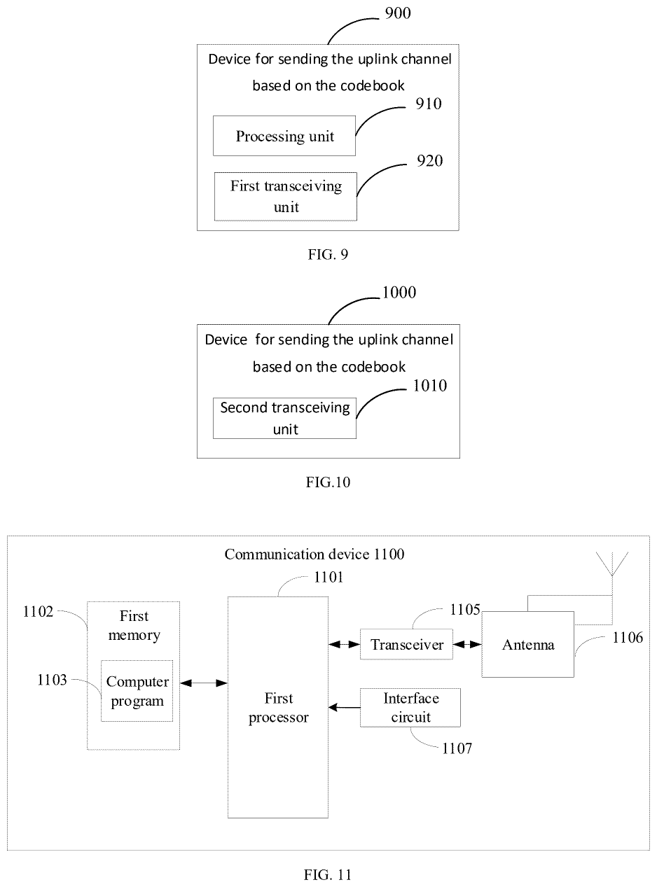

FIG. 10 is a schematic structural diagram of a device for sending the uplink channel based on the codebook according to an embodiment of the present disclosure. The device is applied to a network device.

As shown in FIG. 10, a device 1000 for sending the uplink channel based on the codebook includes: a second transceiving unit 1010, where the second transceiving unit 1010 is configured to receive an uplink data channel that is precoded with a codeword in a codebook and sent by a terminal device, where the codebook matches a number of antenna ports used by the terminal device for sending the uplink channel, there are a plurality of antenna ports for the uplink channel, and polarization directions of the plurality of antenna ports are same.

As a possible implementation of the embodiment of the present disclosure, the codebook includes at least one of: a codeword set for fully-coherent transmission; the codeword set for partial-coherent transmission; or the codeword set for non-coherent transmission.

As a possible implementation of the embodiment of the present disclosure, the codeword set for the fully-coherent transmission is generated based on a discrete Fourier transform (DFT) beam vector according to dimensional information and oversampling factors of the plurality of antenna ports.

As a possible implementation of the embodiment of the present disclosure, the codeword set for the fully-coherent transmission is determined based on at least one of a first layer codeword or other layer codeword; the first layer codeword is determined based on first indication information and second indication information, where the first indication information and the second indication information are configured to indicate a DFT beam corresponding to the first layer codeword; and a DFT beam corresponding to the other layer codeword is determined based on third indication information, where the third indication information is configured to indicate an offset of a beam index of the other layer codeword relative to a beam index of the first layer codeword under the dimensional information.

As a possible implementation of the embodiment of the present disclosure, each of at least one piece of dimensional information of the plurality of antenna ports supports a plurality of groups of the oversampling factors.

As a possible implementation of the embodiment of the present disclosure, the codeword set for the partial-coherent transmission is determined based on a number of antenna ports in each antenna port group of a plurality of antenna port groups and antenna correlation among the plurality of antenna port groups, where the plurality of antenna port groups are divided based on the plurality of antenna ports.

As a possible implementation of the embodiment of the present disclosure, the codeword set for the non-coherent transmission is determined based on an antenna selection vector corresponding to the number of antenna ports.

According to the device for sending the uplink channel based on the codebook provided in the embodiment of the present disclosure, the uplink data channel, which is precoded with the codeword in a codebook and sent by the terminal device, is received. In a case that there are the plurality of antenna ports for the uplink sending and polarization directions of the plurality of antenna ports are same, the terminal device may determine the codebook that matches the number of antenna ports used by the terminal device for sending the uplink channel and send the uplink data channel precoded with the codeword in the codebook to the network device. The network device may receive the uplink data channel that is precoded with the codeword in the codebook and sent by the terminal device. Performing uplink transmission based on the codebook can realize spatial multiplexing of uplink channel precoding, which effectively increases the rate of uplink channel transmission, and enhances the communication efficiency.

Referring to FIG. 11, FIG. 11 is a schematic structural diagram of a communication device according to an embodiment of the present disclosure. A communication device 1100 may be the network device, or may be the terminal device, or may be a chip, a chip system or a processor that supports the network device to implement the above-mentioned methods, or may be a chip, a chip system or a processor that supports the terminal device to implement the above-mentioned methods. The device may be configured to implement the methods described in the above-mentioned method embodiments. For details, please refer to the description in the above-mentioned method embodiments.

The communication device 1100 may include one or more first processors 1101. The first processor 1101 may be a general-purpose processor or a special-purpose processor, or the like. For example, the processor may be a baseband processor or a central processor. The baseband processor may be configured to process a communication protocol and communication data, and the central processor may be configured to control the device for sending the uplink channel based on the codebook (such as a base station, a baseband chip, a terminal device, a terminal device chip, a DU or CU, or the like), execute a computer program, and process data of the computer program.

Optionally, the communication device 1100 may further include one or more first memories 1102 that store a computer program 1103, where the computer program 1103, when collectively executed by the one or more first processors 1101, causes the communication device 1100 to perform the method described in the above method embodiment. The computer program 1103 may be solidified in the one or more first processors 1101, in which case the one or more first processors 1101 may be implemented by using hardware.

Optionally, the first memory 1102 may further store data. The device 1000 for sending the uplink channel based on the codebook and the first memory 1102 may be arranged separately or may be integrated together.

Optionally, the communication device 1100 may further include a transceiver 1105 and an antenna 1106. The transceiver 1105 may be referred to as a transceiving unit, a transceiving machine, or a transceiving circuit, configured to implement a transceiving function. The transceiver 1105 may include a receiver and a transmitter, where the receiver may be referred to as a receiving machine or a receiving circuit, configured to implement a receiving function; and the transmitter may be referred to as a transmitting machine or a transmitting circuit, configured to implement a transmitting function.

Optionally, the communication device 1100 may further include one or more interface circuits 1107. The interface circuit 1107 is configured to receive code instructions and send the code instructions to the one or more first processors 1101. The one or more first processors 1101 collectively execute code instructions to cause the communication device 1100 to perform the method described in the above method embodiment.

In an implementation, the one or more first processors 1101 may include a transceiver for implementing receiving and transmitting functions. For example, the transceiver may be a transceiving circuit, or an interface, or an interface circuit. The transceiving circuit, interface and interface circuit for implementing receiving and transmitting functions may be separated or may be integrated together. The transceiving circuit, interface or interface circuit may be configured to read and write codes/data, or the transceiving circuit, interface or interface circuit may be configured to transmit or transfer signals.

As used herein, the term processor may refer to one processor that performs the defined functions or a plurality of processors that collectively perform defined functions, such that the execution of the individual defined functions may be divided amongst such processors.

In an implementation, the communication device 1100 may include a circuit, where the circuit may implement the function of transmitting or receiving or communicating in the aforementioned method embodiment. The processor and the transceiver described in the present disclosure may be implemented on an Integrated Circuit (IC), an analog IC, a radio frequency integrated circuit (RFIC), a mixed-signal IC, an Application Specific Integrated Circuit (ASIC), a Printed Circuit Board (PCB), an electronic device, or the like. The processor and the transceiver may further be manufactured using various IC process technologies, such as Complementary Metal Oxide Semiconductor (CMOS), NMetal-Oxide-Semiconductor (NMOS), Positive Channel Metal Oxide Semiconductor (PMOS), Bipolar Junction Transistor (BJT), Bipolar CMOS (BiCMOS), silicon germanium (SiGe), and gallium arsenide (GaAs), etc.

The communication device described in the above embodiment may be a network device or a terminal device. However, the scope of the communication device described in the present disclosure is not limited to this. Moreover, the structure of the communication device may not be limited by FIGS. 9-10. The communication device may be an independent device or may be a part of a larger device. For example, the communication device may be:
(1) an independent integrated circuit (IC), or a chip, or a chip system or subsystem;
(2) a collection with one or more ICs, optionally, which may further include a storage component for storing data and computer programs;
(3) an ASIC, such as a Modem;
(4) a module capable of being embedded in another device;
(5) a receiver, a terminal device, an intelligent terminal device, a cellular phone, a wireless device, a handheld phone, a mobile unit, a vehicle-mounted device, a network device, a cloud device, an artificial intelligence device, or the like; and
(6) miscellaneous.

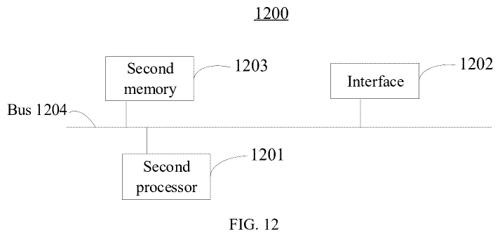

For a case where the communication device may be a chip or a chip system, please refer to a schematic structural diagram of a chip 1200 shown in FIG. 12. The chip 1200 shown in FIG. 12 includes a second processor 1201 and an interface 1202, where there may be one or more second processors 1201, and there may be a plurality of interfaces 1202.

For a case where the chip 1200 is configured to implement the function of the network device in the embodiment of the present disclosure:
the interface 1202 is configured to receive code instructions and send the code instructions to the processor; and
the second processor 1201 is configured to execute the code instructions to perform the methods as shown in FIGS. 2, 3, 5, 6 and 7.

For a case where the chip 1200 is configured to implement the function of the terminal device in the embodiment of the present disclosure:
the interface 1202 is configured to receive code instructions and send the code instructions to the processor; and
the second processor 1201 is configured to execute the code instructions to perform the method as shown in FIG. 8.

Optionally, the chip 1200 further includes a second memory 1203 for storing necessary computer programs and data. Optionally, the chip 1200 further includes a bus 1204.

Those having ordinary skill in the art may further understand that various illustrative logical blocks and steps that are listed in the embodiments of the present disclosure may be implemented by using electronic hardware, computer software, or a combination of thereof. Whether the functions are implemented by using hardware or software depends on a specific application and a design requirement of an entire system. Those having ordinary skill in the art may use various methods to implement the functions for each particular application, but it should not be considered that the implementation goes beyond the protection scope of the embodiments of the present disclosure.

An embodiment of the present disclosure further provides a communication system. The system includes the device for sending the uplink channel based on the codebook as the terminal device and the device for sending the uplink channel based on the codebook as the network device in the embodiments of FIGS. 9-10, or the system includes the communication device as the terminal device and the communication device as a network device in the embodiment of FIG. 11.

The present disclosure further provides a non-transitory readable storage medium storing instructions, where the instructions, when executed by a computer, implement the functions of any one of the above method embodiments.

The present disclosure further provides a computer program product, where the computer program product, when executed by a computer, performs the functions of any one of the above method embodiments.

All or some of the foregoing embodiments may be implemented by using software, hardware, firmware, or any combination thereof. When the software is used to implement the embodiments, the embodiments may be implemented completely or partially in a form of a computer program product. The computer program product includes one or more computer programs. When the computer program is loaded and executed on a computer, all or some of procedures or functions according to the embodiments of the present disclosure are generated. The computer may be a general-purpose computer, a dedicated-purpose computer, a computer network, or another programmable device. The computer program may be stored in a non-transitory computer-readable storage medium or may be sent from a non-transitory computer-readable storage medium to another non-transitory computer-readable storage medium. For example, the computer program may be sent from a website, computer, server, or data center to another website, computer, server, or data center in a wired (for example, a coaxial cable, an optical fiber, or a Digital Subscriber Line (DSL)) or wireless (for example, infrared, radio, or microwave) manner. The non-transitory computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a Digital Video Disc, (DVD)), a semiconductor medium (for example, a Solid State Disk (SSD)), or the like.

Those having ordinary skill in the art may understand that various numerals such as “first” and “second” involved in the present disclosure are merely used for differentiation for ease of description, and are not used to limit the scope of embodiments of present disclosure or represent a sequence.

“At least one” in the present disclosure can also be described as one or more, and “a plurality of” can also be described as two, three, four or more, which will not be limited in the present disclosure. In the embodiments of the present disclosure, for a technical feature, technical features of the technical feature are distinguished by “first,” “second,” “third,” “A,” “B,” “C,” and “D,” etc. The technical features described by “first,” “second,” “third,” “A,” “B,” “C,” and “D” have no order of precedence or magnitude.

The correspondences shown in the tables in the present disclosure may be configured or may be predefined. The values of the information in each table are only examples and can be configured as other values, which are not limited in the present disclosure. When configuring the correspondences between information and parameters, it is not necessary to configure all the correspondences shown in each table. For example, in the tables in the present disclosure, the correspondences shown by some rows may not be configured. For another example, appropriate deformation adjustments may be made based on the above table, such as splitting, merging and so on. Names of the parameters shown in titles of the foregoing tables may optionally be other names that can be understood by a communications device, and values or representation manners of the parameters may optionally be other values or representation manners that can be understood by the communications device. During implementation of the foregoing tables, another data structure, such as an array, a queue, a container, a stack, a linear table, a pointer, a linked list, a tree, a graph, a structure, a class, a pile, or a hash table, may optionally be used.

“Predefine” in the present disclosure may be understood as “define,” “pre-define,” “store,” “pre-store,” “pre-negotiate,” “pre-configure,” “solidify,” or “pre-burn”.

Those having ordinary skill in the art may be aware that units and algorithm steps in the examples described with reference to the embodiments disclosed herein may be implemented by using electronic hardware or a combination of computer software and electronic hardware. Whether the functions are performed by using hardware or software depends on a particular application and a design constraint condition of the technical solution. Those having ordinary skill in the art may use different methods to implement the described functions for each particular application, but it should not be considered that the implementation goes beyond the scope of the present disclosure.

It may be clearly understood by those having ordinary skill in the art that, for the purpose of convenient and brief description, for a detailed working process of the foregoing system, device and unit, refer to a corresponding process in the foregoing method embodiments, which will not be repeated here.

It should be understood that steps can be reordered, added, or removed using the various forms of processes shown above. For example, the steps described in the embodiments of the present disclosure can be performed in parallel, sequentially or in a different order, so long as the desired result of the technical solution disclosed in the present disclosure can be achieved, which will not be limited herein.

The above specific implementation does not limit the protection scope of the present disclosure. Those having ordinary skilled in the art should understand that various modifications, combinations, sub-combinations, and substitutions can be made according to design requirements and other factors. Any modification, equivalent substitution and improvement made within the spirit and principle of the present disclosure should be included in the protection scope of the present disclosure.

1. A method for sending an uplink channel based on a codebook, performed by a terminal device, the method comprising:
determining the codebook that matches a number of antenna ports used by the terminal device for sending the uplink channel, wherein there are a plurality of antenna ports for the uplink channel, and polarization directions of the plurality of antenna ports are same;
precoding the uplink channel with a codeword in the codebook; and
sending a precoded uplink data channel to a network device.

2. The method according to claim 1, wherein the codebook comprises at least one of:
a codeword set for fully-coherent transmission;
the codeword set for partial-coherent transmission; or
the codeword set for non-coherent transmission.

3. The method according to claim 2, further comprising:
determining dimensional information and oversampling factors of the plurality of antenna ports; and
generating the codeword set for the fully-coherent transmission based on a discrete Fourier transform (DFT) beam vector according to the dimensional information and the oversampling factors.

4. The method according to claim 3, wherein generating the codeword set for the fully-coherent transmission based on the DFT beam vector according to the dimensional information and the oversampling factors comprises:
determining first indication information and second indication information, wherein the first indication information and the second indication information are configured to indicate a DFT beam corresponding to a first layer codeword;
determining third indication information, wherein the third indication information is configured to indicate an offset of a beam index of other layer codeword relative to a beam index of the first layer codeword under the dimensional information;
determining a DFT beam corresponding to the other layer codeword based on the third indication information; and
determining the codeword set for the fully-coherent transmission based on at least one of the first layer codeword or the other layer codeword.

5. The method according to claim 3, wherein each of at least one piece of dimensional information of the plurality of antenna ports supports a plurality of groups of the oversampling factors.

6. The method according to claim 2, further comprising:
dividing the plurality of antenna ports into a plurality of antenna port groups; and
determining the codeword set for the partial-coherent transmission based on a number of antenna ports in each antenna port group and antenna correlation among the plurality of antenna port groups.

7. The method according to claim 2, further comprising:
determining the codeword set for the non-coherent transmission based on an antenna selection vector corresponding to the number of antenna ports.

8. A method for sending an uplink channel based on a codebook, performed by a network device, comprising:
receiving an uplink data channel that is precoded with a codeword in the codebook and sent by a terminal device,
wherein the codebook matches a number of antenna ports used by the terminal device for sending the uplink channel, there are a plurality of antenna ports for the uplink channel, and polarization directions of the plurality of antenna ports are same.

9. The method according to claim 8, wherein the codebook comprises at least one of:
a codeword set for fully-coherent transmission;
the codeword set for partial-coherent transmission; or
the codeword set for non-coherent transmission.

10. The method according to claim 9, wherein
the codeword set for the fully-coherent transmission is generated based on a discrete Fourier transform (DFT) beam vector according to dimensional information and oversampling factors of the plurality of antenna ports.

11. The method according to claim 10, wherein
the codeword set for the fully-coherent transmission is determined based on at least one of a first layer codeword or other layer codeword;
the first layer codeword is determined based on first indication information and second indication information, wherein the first indication information and the second indication information are configured to indicate a DFT beam corresponding to the first layer codeword; and
a DFT beam corresponding to the other layer codeword is determined based on third indication information, wherein the third indication information is configured to indicate an offset of a beam index of the other layer codeword relative to a beam index of the first layer codeword under the dimensional information.

12. The method according to claim 10, wherein each of at least one piece of dimensional information of the plurality of antenna ports supports a plurality of groups of the oversampling factors.

13. The method according to claim 9, wherein
the codeword set for the partial-coherent transmission is determined, based on a number of antenna ports in each antenna port group of a plurality of antenna port groups and antenna correlation among the plurality of antenna port groups, wherein the plurality of antenna port groups are divided based on the plurality of antenna ports.

14. The method according to claim 9, wherein
the codeword set for the non-coherent transmission is determined based on an antenna selection vector corresponding to the number of antenna ports.

15-16. (canceled)

17. A communication device, comprising:
one or more processors; and
a memory that stores a computer program,
wherein the computer program, when collectively executed by the one or more processors, causes the communication device to:
determine a codebook that matches a number of antenna ports used by a terminal device for sending an uplink channel, wherein there are a plurality of antenna ports for the uplink channel, and polarization directions of the plurality of antenna ports are same;
precode the uplink channel with a codeword in the codebook; and
send a precoded uplink data channel to a network device.

18. A communication device, comprising: one or more processors and an interface circuit,
wherein the interface circuit is configured to receive code instructions and send the code instructions to the one or more processors; and
the one or more processors are configured to collectively execute the code instructions to perform the method according to claim 1.

19. A non-transitory computer-readable storage medium storing instructions, wherein the instructions, when executed, implements the method according to claim 1.

20. (canceled)

21. The communication device according to claim 17, wherein the codebook comprises at least one of:
a codeword set for fully-coherent transmission;
the codeword set for partial-coherent transmission; or
the codeword set for non-coherent transmission.

22. The communication device according to claim 21, the communication device is further configured to:
determine dimensional information and oversampling factors of the plurality of antenna ports; and
generate the codeword set for the fully-coherent transmission based on a discrete Fourier transform (DFT) beam vector according to the dimensional information and the oversampling factors.

23. A non-transitory computer-readable storage medium storing instructions, wherein the instructions, when executed, implements the method according to claim 8.
